(19) United States
(12) Patent Application Publication
(10) Pub. No.: US 2008/0077260 A1
(43) Pub. Date: Mar. 27, 2008

(54) Refrigeration system fault detection and diagnosis using distributed microsystems

(76) Inventors: Michael Ramey Porter, Antioch, TN (US); Joseph James Rozsnaki, Sagamore Hills, OH (US); Osman Ahmed, Hawthorn Woods, IL (US)

Correspondence Address: Elsa Keller, Legal Assistant;Intellectual Property Department, Siemens Corporation, 170 Wood Avenue South, Iselin, NJ, 08830, US

(21) Appl. No.: 11/786,033

(22) Filed: Apr. 10, 2007

Related U.S. Application Data
(60) Provisional application No. 60/846,919, filed on Sep. 25, 2006.
(60) Provisional application No. 60/846,459, filed on Sep. 22, 2006.
(60) Provisional application No. 60/847,058, filed on Sep. 25, 2006.

(51) Int. Cl. G05F 1/00

(52) U.S. Cl. 700/90

(57) ABSTRACT

A method and/or apparatus determines whether a refrigeration (or other cooling) related system is operating within normal parameters by comparing reference data derived from ideal or normal conditions within the system. Data regarding the actual operating parameters of the system is provided via a set of microsystem sensors disposed throughout the refrigeration or cooling system. The sensors are in some embodiments wireless, and in some advantageous embodiments includes MEMs sensors.

This application claims the benefit of U.S. Provisional Application Ser. No. 60/846,459, filed Sep. 22, 2006, U.S. Provisional Application Ser. No. 60/847,058, filed Sep. 25, 2006, U.S. Provisional Application Ser. No. 60/846,919, filed Sep. 25, 2006, all of which are incorporated herein by reference.

### CROSS-REFERENCE TO RELATED APPLICATIONS

Cross-reference is made to U.S. patent application Ser. No. ______ (Atty Docket No. 1867-0147, Express Mail No. EV961072133US), filed Apr. 9, 2007, and U.S. patent application Ser. No. ______ (Atty Docket No. 1867-0148, Express Mail No. EV961072178US), filed Apr. 9, 2007.

### FIELD OF THE INVENTION

The present invention relates to cooling systems, and more particularly, to commercial refrigeration systems and cooling subsystems of HVAC systems.

### BACKGROUND OF THE INVENTION

Cooling systems are used for a variety of purposes, such as for refrigeration or air conditioning. One common type of cooling system is a vapor compression refrigeration system. A vapor compression refrigeration system generally includes, among other things, a compressor, a condenser, an expansion valve, and an evaporator, along with a refrigerant and a series of valves and pipes.

As is known in the art, circulating refrigerant enters the compressor where it is both pressurized and heated as a result of the pressurization. This heated vapor is then passed through the condenser which allows the vapor to dissipate heat and thus change to a liquid state. The condenser acts as a heat exchanger by rejecting the heat of the system to an external medium. The liquid refrigerant then passes through a thermostatic expansion valve (TEV or TXV). The TEV creates a substantial pressure drop causing part of the liquid refrigerant to flash evaporate. The liquid and vapor refrigerant mixture then circulates through the evaporator. While in the evaporator, the ambient air of the space to be cooled warms the refrigerant causing more of the liquid portion to evaporate thus absorbing the heat from the ambient space. Ideally, the refrigerant leaving the evaporator will be mostly vapor. This vapor then passes back into the compressor and the cycle repeats.

One issue that arises is that detection and diagnosis of system faults in commercial refrigeration systems is costly and time consuming. Typically, fault detection first begins when the cooling system fails. Thereafter, a technician travels to the site of the failure, and attempts to identify the fault by manually performing measurements and gathering data from a plurality of devices in the system.

Drawbacks of the current fault handling approaches include the potential damage to perishable objects attributable to delays in fault detection and correction. In addition, the fault diagnosis itself is labor intensive and costly.

There is a need, therefore, for an improved arrangement and method for detection and/or diagnosis of faults in a cooling system that avoids at least some of the drawbacks of the prior art.

### SUMMARY OF THE INVENTION

The present invention addresses the above mentioned issue by incorporating wireless microsystems sensors that may be readily and permanently installed in a cooling system. Wireless microsystem sensors may then be used to monitor a variety of conditions, including by way of example, pressure and temperature of refrigerant at various locations of the system. The data points may be used to detect and/or isolate failures within the system. In some systems, the data may merely be gathered for use by a technician for diagnosis. In other systems, data may be monitored automatically on an ongoing basis so that deterioration of system operation may be detected and failure prevented.

An embodiment of the invention is a method and/or apparatus that determines whether a refrigeration (or other cooling) related system is operating within normal parameters by comparing reference data derived from ideal or normal conditions within the system. Data regarding the actual operating parameters of the system is provided via a set of microsystem sensors disposed throughout the refrigeration or cooling system. The sensors are in some embodiments wireless, and in some advantageous embodiments includes MEMs sensors.

Other embodiments include a plurality of wireless sensors disposed in any of a set of refrigeration device components, or proximate to said components. Such wireless sensors are operable to obtain data regarding operation of the component and communicate the operational information to an FDD processing device. The FDD processing device can communicate an alarm if the sensor data indicates that a particular device or portion of the system is not operating within acceptable parameters.

The use of wireless sensors to obtain data for automated analysis of refrigeration system parameters can provide advance warning of system faults as well as aid in diagnostics.

The above described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic diagram of an exemplary cooling system that incorporates an embodiment of the invention;

FIG. 2 shows an exemplary reference enthalpy curve of a system as well as an illustration of a non-ideal enthalpy curve.

FIGS. 3 and 4 show an exemplary microsystem that may be used in the embodiment of FIG. 1;

FIG. 5 shows a schematic diagram of another exemplary cooling system that incorporates another embodiment of the invention; and

FIG. 6 shows an exemplary embodiment of a coupling device that may be used to obtain system data.

### DETAILED DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

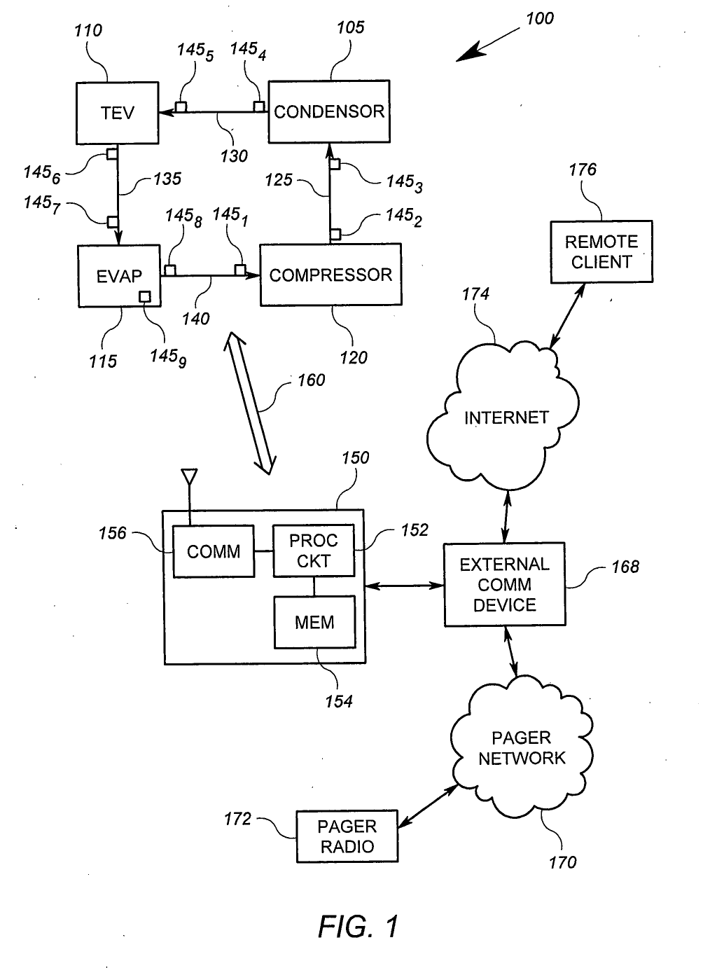

FIG. 1 shows a schematic diagram of a generalized refrigeration system 100 that includes an arrangement according to an embodiment of the invention. The refrigeration system 100 includes a condensor 105, a thermostatic expansion valve (TEV) 110, an evaporator 115, a compressor 120, a first refrigerant path 125, a second refrigerant path 130, a third refrigerant path 135 and a fourth refrigerant path 140. The arrangement according to the invention includes a plurality of microsystems 145₁-145₉ and a controller unit 150 having a processing circuit 152, a memory 154 and a communication circuit 156. In this embodiment, the arrangement further includes an external communication device 168.

The generalized refrigeration system 100 operation is well known in the art. The compressor 120 operates to increase the pressure and temperature of the refrigerant. The high pressure, high temperature refrigerant passes through a first refrigerant path 125 to the condenser 105. The condenser 105 extracts the heat from the high pressure, high temperature refrigerant, which results in condensation and a drop in temperature of the refrigerant. In many cases, the condenser 105 is located external to the building in which the system 100 is located such that extracted heat can be expelled to the external atmosphere. The high pressure, lower temperature refrigerant then passes through the second refrigerant path 130 to the TEV 110. As indicated by its name, the TEV 110 expands the refrigerant such that it has very low pressure. Ideally, the heat content does not change during this expansion and thus the expansion results in a temperature drop to create a very low temperature refrigerant. In addition, the abrupt temperature drop causes flash evaporation. The low pressure, low temperature refrigerant passes through the third refrigerant path 135 to the evaporator 115. The evaporator 115 exchanges heat between the area to be cooled and the refrigerant, typically by blowing warmer air from the area to be cooled over the coils of the evaporator 115. As a result of the heat exchange, the refrigerant absorbs heat and becomes somewhat warmer, and further evaporates. The refrigerant then passes through the fourth refrigerant path 140 to the compressor 120. In the compressor 120, the refrigerant is again compressed, resulting in a temperature and pressure increase.

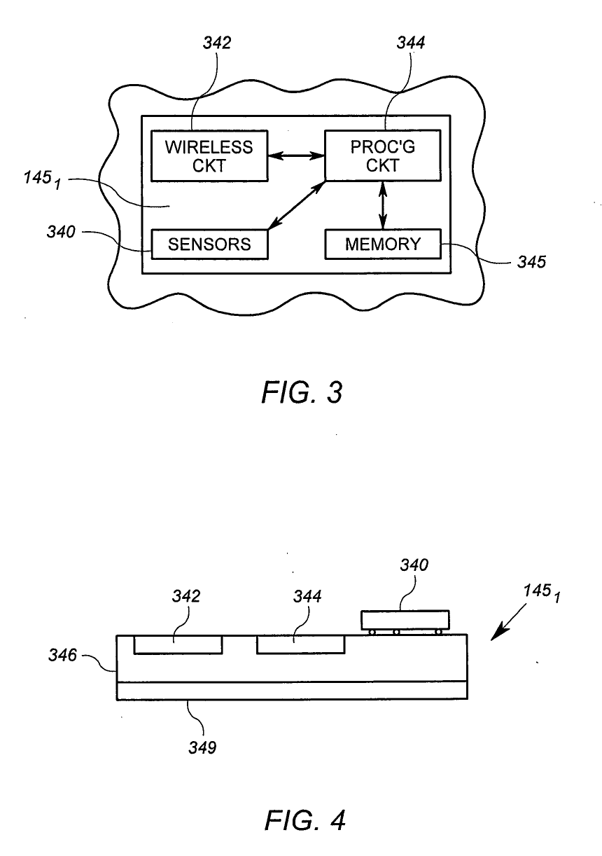

Referring now to the arrangement for fault detection, the sensor microsystems 145₁-145₉ are devices that are configured to measure one or more parameters of the refrigerant, or one or more operational parameters of any physical device of the system 100. In the exemplary embodiment described herein, the sensor microsystems 145₁-145₉ are further configured to communicate information representative of the measured parameters to the controller 150 via a communication link 160. To this end, the sensor microsystems 145₁-145₉ include wireless communication circuits, and use wireless communications as at least part of the communication link 160. Further details regarding an exemplary embodiment of the microsystems 145₁-145₉ are provided below in connection with FIGS. 3 and 4.

In the embodiment described herein, a first microsystem 145₁ is disposed in position to measure the pressure and temperature of refrigerant at the input of the compressor 120, and a second microsystem 145₂ is disposed in position to measure the pressure and temperature of refrigerant at the output of the compressor 120. In addition, a third microsystem 145₃ is disposed in position to measure the pressure and temperature of refrigerant at the input of the condenser 105, and a fourth microsystem 145₄ is disposed in position to measure the pressure and temperature of refrigerant at the output of the condenser 105. Similarly, a fifth microsystem 145₅ is disposed in position to measure the pressure and temperature of refrigerant at the input of the TEV 110, and a sixth microsystem 145₆ is disposed in position to measure the pressure and temperature of refrigerant at the output of the TEV 110. Also, a seventh microsystem 145₇ is disposed in position to measure the pressure and temperature of refrigerant at the input of the evaporator 115, an eighth microsystem 145₈ is disposed in position to measure the pressure and temperature of refrigerant at the output of the evaporator 115, and a ninth microsystem 145₉ is disposed in position to measure air flow past the coils of the evaporator.

In a general, the arrangement of the microsystems 145₁-145₈ obtain measurements of the refrigerant as various points in the system 100, and provide the measurement information to the controller 150. The microsystem 145₉ obtains measurements of air flow through the evaporator coils and provides the measurement information to the controller 150.

As discussed above, the controller 150 includes a communication circuit 156. The communication circuit 156 is configured to receive messages including the measurement information from the microsystems 145₁-145₉ and provide the measurement information to the processing circuit 152. The processing circuit 152 within the controller 150 compares information pertaining to the measurements to one or more predetermined reference values or thresholds. By way of example, the microsystem 145₉ obtains air flow measurements in the evaporator 115 and provides the measurement information to the controller 150. The processing circuit 152 within the controller 150 uses the flow measurement information to ensure proper operation of the evaporator fan, not shown in FIG. 1, but would be known to those of skill in the art. In other examples, which will be discussed below in further detail, the processing circuit 152 determines a change in measured values between two points of the system 100, and compares that change to expected values for the change.

The external communication circuit 168 is a device that is operably connected to receive fault or alarm information from the controller 150 and to transmit corresponding fault or alarm information to a remote device. For example, the external communication circuit 168 may include an internet modem and electronic mail server. In such a case the communication circuit 168 would be operable to transmit alarm information over the Internet 174 to a remote mail client 176 such as a computer work station or portable communication device. In another embodiment, the external communication circuit 168 may include a pager radio that is operable to transmit alarm information via a pager network 170 to a remote pager radio or receiver 172. The external communication circuit 168 may suitably be part of a computer workstation that has Internet connectivity.

In a first operation, the microsystem 145₁ and the microsystem 145₂ obtain temperature and pressure measurements of the refrigerant at the input and output, respectively, of the compressor 120. The microsystems 145₁ and 145₂ transmit the temperature and pressure information to the controller 150. To this end, each of the Microsystems 145₁ and 145₂ transmits their respective temperature and pressure information wireless to another wireless device. For example, the other wireless device may be a communication circuit 156 of the controller 150, or another one of the Microsystems 145ₓ. In the latter case, each of the microsystems 145₁-145₉ may act as relay devices forming a short range wireless mesh network between any one microsystem 145ₓ and the communication circuit 156 of the controller 150.

In any event, the microsystems 145₁ and 145₂ transmit messages to the communication circuit 156 that include the measurement information as well as identification information. In particular, the microsystem 145₁ transmits a message that includes pressure measurement information P₁ and temperature measurement information T₁ as well as information identifying that the values T₁ and P₁ represent temperature and pressure at or near the input of the compressor 120. The identification information may suitably be information identifying the source of the measurement (microsystem 145₁), and/or information that identifies the location at which values T₁ and P₁ were measured. In any event, sufficient identification information is provided such that the controller 150 (and/or other devices) associates P₁ and T₁ as pressure and temperature measurements corresponding to the input of the compressor 120. In a similar manner, the microsystem 145₂ transmits a message that includes pressure measurement information P₂ and temperature measurement information T₂ as well as information identifying that the values T₂ and P₂ represent temperature and pressure at or near the output of the compressor 120.

The communication circuit 156 of the controller 150 receives the messages from the microsystems 145₁ and 145₂. The processing circuit 152 receives from the communication circuit 156 the pressure and temperature information, P₁, T₁, respectively, as well as the pressure and temperature information P₂, T₂, respectively, from the communication circuit 156. The processing circuit 152 then performs comparisons using one or more of the values P₁, T₁, P₂, or T₂, and one or more reference values to determine whether the compressor 120 is exhibiting an operational fault.

By way of example, the processing circuit 152 may compare the absolute temperature T₁ at the input of the compressor 120 to reference values in the form of threshold value tchi. The threshold value tchi represents a maximum acceptable temperature for the refrigerant at the input of the compressor 120. If the temperature at the input of the compressor 120 is too high, then it is an indication that the refrigeration system is operating inefficiently due to a fault. The fault may be due to excess heat being added to the system by lack of insulation, or failure of another device such as the TEV 110.

If the temperature T₁ is above dtchi, then a corresponding alarm message may be generated. The alarm message identifies which threshold is exceeded, and preferably includes a time and date stamp. In some cases, the alarm message further includes, or is at least linked to, measurement data from other portions of system 100, such as temperature and/or pressure measurements from other microsystems 145₃-145₈, or other types of measurements from other Microsystems, not shown, but discussed further below.

The processing circuit 152 stores the generated alarm message in the memory 154 of the controller 150. The processing circuit 152 preferably stores in the alarm message an identification of a refrigeration system device associated with the alarm condition. The processing circuit 152 is configured to associate each alarm condition with one or more devices that typically are the cause of the error. For example, if the processing circuit 152 determines that the value of T₁ is above tchi, then the processing circuit 152 may suitably store information identifying the input of the compressor 120 as the source of the alarm. Other associations of devices with out-of-bounds measurements would be known to those of ordinary skill in the art.

Information representative of the alarm message may also be transmitted to an external device. To this end, the communication circuit 156 provides the message to the external communication device 168. The external communication circuit 168 transmits information representative of the alarm message to a remote device, such as the pager radio 172, or to the remote e-mail client. The alarm message preferably includes an identification of the device that is exhibiting non-normal behavior.

Referring again to the processing circuit 152, it is noted that the compressor temperature change threshold tchi may be variable, changing as function of various aspects of the system. In general, however, the selection of the compressor temperature threshold tchi is based on the normal or expected operation of the compressor 120 within the system 100. Such thresholds may be determined by those of ordinary skill in the art during the set-up and testing of the refrigeration system 100. The testing of the system 100 can help generate baselines of normal operation, and the thresholds may be based on acceptable variations from the baseline operation. Most thresholds used in the comparisons discussed herein may be generated in a similar manner.

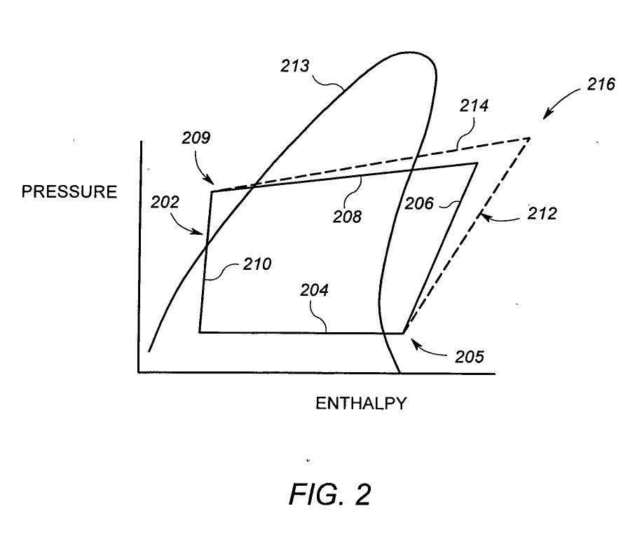

As will be discussed below in connection with FIG. 2, the threshold dtchi, as well as other thresholds related to temperature and pressure T₂, P₁, P₂, may also be derived from a theoretical enthalpy curve for the system.

In addition to the foregoing test, the processing circuit 152 may also perform an analogous comparison of the change in heat or enthalpy, H₂-H₁, to a high and a low heat/enthalpy change thresholds for the compressor 120. In such a case, the heat or enthalpy value H₁ is calculated using the pressure measurement P₁, the temperature measurement T₁, and readily available table data for the type of refrigerant that is in use. Similarly, the heat or enthalpy value H₂ is calculated using the pressure measurement P₂, the temperature measurement T₂, and readily available table data for the refrigerant that is in use. The processing circuit 152 would then provide corresponding alarm messages if any boundary condition is violated.

In another similar operation, the microsystem 145₃ and the microsystem 145₄ obtain temperature and pressure measurements of the refrigerant at the input and output, respectively, of the condensor 105. The microsystems 145₃ and 145₄ transmit messages to the communication circuit 156 that include the measurement information as well as identification information. In particular, the microsystem 145₃ transmits a message that includes pressure measurement information P₃ and temperature measurement information T₃ as well as information identifying that the values T₃ and P₃ represent temperature and pressure at or near the input of the condensor 105. Similarly, the microsystem 145₄ transmits a message that includes pressure measurement information P₄ and temperature measurement information T₄ as well as information identifying that the values T₄ and P₄ represent temperature and pressure at or near the output of the condensor 105.

The communication circuit 156 of the controller 150 receives the messages from the microsystems 145₃ and 145₄. The processing circuit 152 receives the pressure and temperature information, P₃, T₃, respectively, as well as the pressure and temperature information P₄, T₄, respectively, from the communication circuit 156. The processing circuit 152 then performs comparisons using one or more of the values P₃, T₃, P₄, or T₄, and one or more reference values to determine whether the condensor 105 is exhibiting an operational fault.

The comparisons may suitably be analogous to those described above in connection with the compressor 120, except that the reference values are selected to reflect the expected operation of the condenser 105. For example, the processing circuit 152 may compare the heat or enthalpy differences H₄−H₃ to corresponding thresholds, compare temperature or pressure differences T₄−T₃, P₄−P₃ to corresponding thresholds, as well as compare the individual values P₃, P₄, T₃ and T₄ to threshold values.

If the processing circuit 152 determines that one or more of the comparisons identifies an out-of-boundaries condition, the processing circuit 152 generates an alarm message that identifies the condition. As discussed above, the processing circuit 152 then stores and/or forwards the alarm message information via the external communication device 168.

In another operation, the microsystem 145₅ and the microsystem 145₆ obtain temperature and pressure measurements of the refrigerant at the input and output, respectively, of the thermostatic expansion valve (TEV) 110. In the same manner as the other microsystems 145₁, 145₂, etc., the microsystems 145₅ and 145₆ transmit the temperature and pressure information to the controller 150.

In particular, the microsystem 145₅ transmits a message that includes pressure measurement information P₅ and temperature measurement information T₅ as well as information identifying that the values T₅ and P₅ represent temperature and pressure at or near the input of the TEV 110. Similarly, the microsystem 145₆ transmits a message that includes pressure measurement information P₆ and temperature measurement information T₆ as well as information identifying that the values T₆ and P₆ represent temperature and pressure at or near the output of the TEV 110.

The communication circuit 156 of the controller 150 receives the messages from the microsystems 145₅ and 145₆. The processing circuit 152 receives the pressure and temperature information, P₅, T₅, respectively, as well as the pressure and temperature information P₆, T₆, respectively, from the communication circuit 156. The processing circuit 152 then performs comparisons using one or more of the values P₅, T₅, P₆, or T₆, and one or more reference values to determine whether the TEV 110 is exhibiting an operational fault.

The comparisons may suitably be analogous to those described above in connection with the compressor 120, except that the reference values are selected to reflect the expected operation of the TEV 110. For example, the processing circuit 152 may compare the heat or enthalpy differences H₆−H₅ to corresponding thresholds, compare temperature or pressure differences T₆−T₅, P₆−P₅ to corresponding thresholds, as well as compare the individual values P₅, P₆, T₅ and T₆ to threshold values.

If the processing circuit 152 determines that one or more of the comparisons identifies an out-of-boundaries condition, the processing circuit 152 generates an alarm message that identifies the condition. As discussed above, the processing circuit 152 then stores and/or forwards the alarm message information via the external communication device 168.

In yet another operation, the microsystem 145₇ and the microsystem 145₈ obtain temperature and pressure measurements of the refrigerant at the input and output, respectively, of the evaporator 115. In the same manner as the other microsystems 145₁, 145₂, etc., the microsystems 145₇ and 145₈ transmit the temperature and pressure information to the controller 150. The processing circuit 152 of the controller 150 then performs comparisons to determine whether a particular characteristic of the pressure and temperature is indicative of a fault, in the manner described above in connection with the measurements from the microsystems 145₁-145₆.

In addition, the microsystem 145₉ provides air flow information representative of the air flow through the evaporator 115. In many cases, the evaporator 115 will include at least one fan, not shown, that blows air past the heat exchanger of the evaporator 115. If the fan(s) is/are not working properly, then the heat exchange will be inefficient. Accordingly, it is helpful to determine whether the fan(s) is/are working properly. To this end, the microsystem 145₉ transmits a message that includes the air flow information as well as corresponding identifying information to the controller 150. The controller 150 may then compare the air flow information to a corresponding threshold. If the fan is inoperative, then the air flow value will fall below the threshold.

If the processing circuit 152 determines that one or more of the comparisons identifies an out-of-boundaries condition, the processing circuit 152 generates an alarm message that identifies the condition. The alarm message is then stored in the memory 154 of the controller 150, and may be later transmitted to an external device, as discussed further above.

It will be appreciated that the above operations are merely exemplary. It will also be appreciated that the selection of thresholds will depend on the operation characteristics of the compressor 120, condenser 105, TEV 110, evaporator 115, and even the entire system 100 itself.

As briefly mentioned above, at least some of the thresholds or reference values against which measured values are compared may be derived from system characteristics. One system characteristic from which reference values may be derived is the system enthalpy curve. To this end, a set of thresholds for changes in pressure or refrigerant between select pairs of the microsystems 145₁-145₈ may be derived at least in part from a reference or desired enthalpy curve for the system 100.

In particular, FIG. 2 shows an exemplary reference enthalpy curve 202 of the system 100. The enthalpy curve 202 represents the system 100 operating within normal or expected parameters. The enthalpy curve 202 may be defined from system design parameters, and/or from test operations of the system 100. An exemplary method of developing an enthalpy curve such as the enthalpy curve 202 for a particular refrigerant is provided at wwwjsrae.or.jp/jsrae/stady/Eng %20saikuru.htm. The enthalpy curve 202 has four legs 204-210, as is known in the art, representing transitions in pressure and heat (i.e. enthalpy) throughout various steps of the thermal process. The leg 204 represents the changes to the refrigerant as it passes through the evaporator 115. The heat content of the refrigerant rises as the evaporator 115 absorbs heat in the compartment to be cooled. The leg 206 represents the effects of the compressor 120 on the refrigerant, in which case the refrigerant is compressed, preferably nearly isoentropically, and with only small gains in heat. The leg 208 represents the refrigerant passing through the condenser 105, at which point the heat content of the refrigerant is reduced. The leg 210 represents the refrigerant passing through the thermostatic expansion valve 110. The regions 209 of the legs 208 and 210 that are beyond the saturated liquid line 213 represent conditions in which the refrigerant is sub-cooled, as is known in the art. The regions 205 of the legs 204, 206 and 208 that are beyond the saturated vapor line 213 represent conditions in which the refrigerant is super-heated.

When the system 100 is operating properly, the curve 202 approximates the actual heat content (or enthalpy) and the actual pressure of the refrigerant at the various points in the system 100. However, if the system 100 is operating inefficiently, the enthalpy curve will have a different appearance than that of the reference enthalpy curve 202. The curve 216, for example, illustrates an inefficient operation of the compressor 120. The variance of the legs 212 and 214 from the reference curve legs 206 and 208 represent inefficiency and energy loss, and may result from a faulty component.

The solid line reference enthalpy curve 202 may be used, by way of example, to determine the reference values or set points for the various operations described above. For example, because the condenser 105 and the evaporator 115 ideally do not reduce or increase the pressure of the refrigerant, the thresholds for the pressure change between microsystems 145₃ and 145₄ (i.e. P₄−P₃), and between microsystems 145₇ and 145₈ (i.e. P₈−P₇), may be set such that they identify any non-trivial changes in pressure. For example, such a test could determine if the absolute value of P₄−P₃ exceeds an alarm threshold thpc.

As briefly mentioned above, the reference enthalpy curve 202 may also be used to generate thresholds for the changes in heat, pressure and/or temperature in the compressor 120 and the TEV 110 (as well as other devices). For example, the temperature and pressure measurement from each microsystem 145₁-145₈ may be converted to a heat value using available data on the thermodynamic properties of the refrigerant. Such conversion may take place in the microsystem itself or at the controller 150. If the measured heat change (calculated from measured temperature and pressure values) exceeds a threshold for those devices, then there is an indication of a fault. The threshold is derived from the enthalpy curve 202.

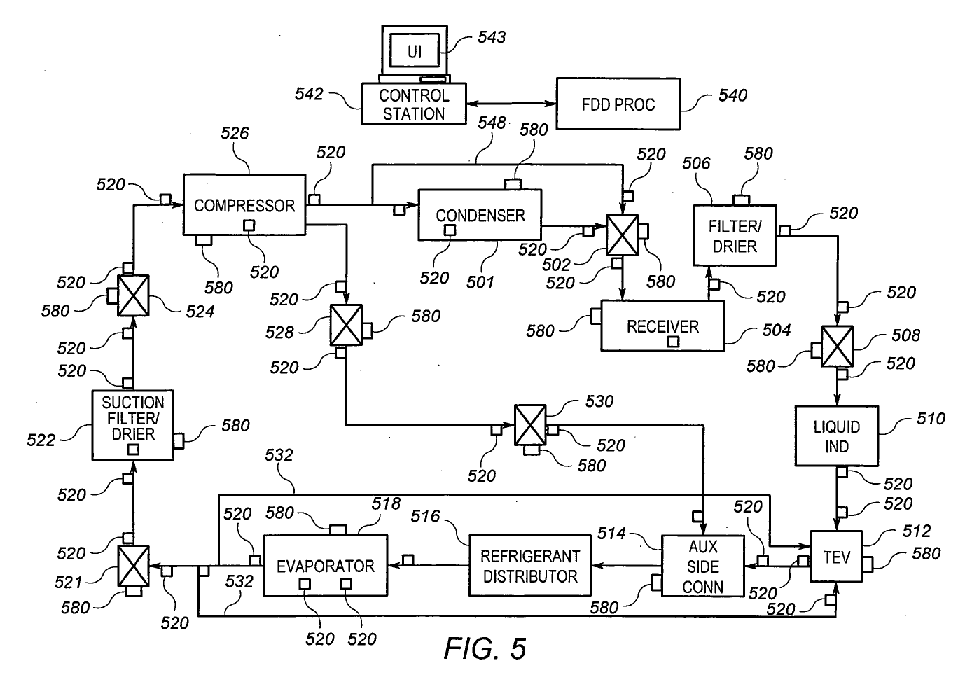

It will also be appreciated that the enthalpy curve 202 may be used in a similar manner to test more than individual devices. In particular, as will be described further below in connection with FIG. 5, a refrigeration system typically includes more than a compressor, condenser, TEV and evaporator. As a result, the enthalpy cycle of a typical refrigeration system is not completely defined by the actions of those four elements.

In one alternative operation, the system 100 may be tested by comparing pressure, temperature or heat change over the entire portion of the system 100 between an input of one device and an input of another device. Such a measurement would provide a more complete reading of a portion of the enthalpy cycle of the system. In particular, the enthalpy cycle of the system 100 is not represented merely by the operations of the condenser 105, TEV 110, evaporator 115 and compressor 120, but also by the devices and conduits that connect those devices. Thus, for example, the leg 208 of the enthalpy curve 202 of FIG. 2 actually corresponds to the condenser 105 and the refrigerant path 130, the leg 210 of FIG. 2 corresponds to the TEV 110 and the refrigerant path 135, the leg 204 of FIG. 2 corresponds to the evaporator 115 and the refrigerant path 140, and the leg 206 corresponds to the compressor 120 and refrigerant path 125.

To this end, the processing circuit 152 performs an operation that measures the difference in pressure in the portion of the system 100 that includes the condenser 105 and the third refrigerant path 130, which corresponds to the enthalpy curve leg 208 as discussed above. In particular, the processing circuit 152 compares the difference in pressure P₅−P₃ with reference values that have been generated based on the leg 208 of the reference enthalpy curve 202. Similarly, the processing circuit 152 compares the differences in pressure P₇−P₅ and/or heat H₇−H₅ with reference values that have been generated based on the leg 210 of the reference enthalpy curve 202, compares the difference in pressure P₁−P₇ with reference values generated based on the leg 204 of reference enthalpy curve 202, and compares the differences P₃−P₁ and/or H₃−H₁ with reference values that have been generated based on the leg 206 of the reference enthalpy curve 202.

Again, if an alarm condition or fault circumstance is detected, the processing circuit 156 generates an exceed message or alarm message, which may be stored, transmitted and/or displayed.

In yet another operation, the arrangement of FIG. 1 may be used to detect unusual or unexpected differences in pressure or temperature as the refrigerant passes through any of the refrigerant paths 125, 130, 135 and 140. Such information may be used for early detection of a fault in a minor element of the system, and/or leaks or faulty insulation. For example, if a large temperature increase is detected from one end of the refrigerant path 140 to the other end, (i.e. T₁-T₈), then it may be an indication that insulation on the chilled refrigerant line within the path 140 may be inadequate. In any event, such a temperature increase clearly indicates that cooling capacity is being lost before the refrigerant enters the evaporator 115.

From the foregoing examples, it can be seen that microsystem sensors disposed in various locations of the refrigeration system can provide improved fault detection and diagnostics. By measuring refrigerant parameters such as temperature and pressure throughout the system, as well as other system parameters such as evaporator air flow, sources of inefficiency or malfunction may be readily identified. In fact, through proper setting of the alarm thresholds (reference values), the arrangement for fault detection in FIG. 1 can provide early detection of faults, possibly allowing intervention before a more severe fault occurs.

Because microsystems may be made wireless, with the ability to communicate via short range RF signals, microsystems may be readily implemented in many locations throughout the system, such that a large variety of parameters may be monitored. Moreover, as briefly mentioned above, all of the microsystems 145₁-145₉ cooperate to form a wireless mesh network of RF communications. Thus, it is not necessary for all of the microsystems to have the RF transmission strength to communicate directly with the controller 150. In the wireless mesh network, each of the microsystems 145₁-145₉ acts as a network node that can receive and forward messages from other proximate microsystems 145₁-145₉.

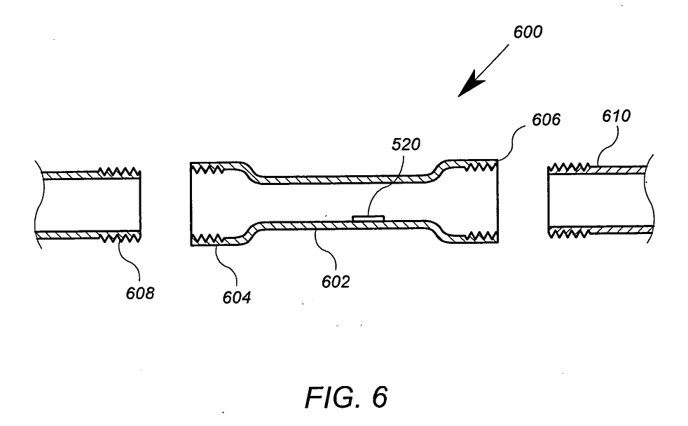

FIGS. 3 and 4 show an exemplary microsystem 145₁ in the form of a sensor module that may be used as any of the microsystems 145₁-145₉ The microsystem 145₁ is designed such that it be affixed to a plurality of devices exposed to a variety of measurable conditions. For example, the microsystem 145₁ may be affixed to the inside of piping at inputs and outputs of various devices, such as the compressor 120, the condenser 105, the TEV 110 and the evaporator 115. FIG. 6, discussed further below, shows a refrigerant pipe coupling device that incorporates a sensor module similar to the microsystem 145₁ according to the invention.

In order to detect or obtain the measurement information (i.e. pressure, temperature, etc.), the microsystem 145₁ includes a sensor device 340 that is configured to measure the specified quantity. The microsystem 145₁ further includes a wireless communication circuit 342 operable to communicate the measurement information (or information derived therefrom) to a remotely located wireless communication circuit, such as the controller 150 of FIG. 1. In the embodiment described herein, the wireless communication circuit 342 is operable to communicate using a wireless mesh network formed by other microsystems 145₂-145₉. Thus, the communication circuit 342 of the microsystem 145₁ does not need to have transmission strength to transmit directly to the controller 150.

In the embodiment described herein, the sensor device 340 is preferably one or more microelectromechanical system sensors or MEMS sensors. MEMS sensors have the advantage of requiring relatively little space and electrical power, and have relatively little mass. For the microsystem 145₁, the sensor device 340 is a set of MEMS sensors that include a pressure sensor and a temperature sensor. A combination MEMS pressure sensor and temperature sensor can readily fit onto a small enough footprint to allow the microsystem 145₁ to fit onto refrigerant piping. Other MEMS sensors or combinations thereof may readily be substituted for the temperature and pressure sensor if the device is intended to measure other quantities.

The processing circuit 344 is operable to generate digital information representative of the sensed quantities and prepare the information in the proper protocol for transmission.

It is preferable if the communication circuit 342 and the processing circuit 344 are incorporated onto the same substrate as the sensor device 340. FIG. 4 shows a side view of the microsystem 145₁ wherein the various components are incorporated into one chip. To allow for incorporation of the communication circuit 342 on a single chip, on-chip Bluetooth communication circuits are known. In addition, methods of attaching MEMS devices to semiconductor substrates is known, such as is taught in connection with FIG. 8 of U.S. patent application Ser. No. 10/951,450 filed Sep. 27, 2004 and which is incorporated herein by reference.

An advantageous embodiment of the sensor module 145₁ is a semiconductor substrate 346 having the processing circuit 344 and the communication circuit 342 formed thereon, and a MEMS sensor device 340 attached thereto, such as by flip-chip bonding. In addition, it would be advantageous to attach a power source such as a battery to the substrate 346. The battery may suitably be a lithium ion coin cell type structure 349 affixed to the side of the semiconductor substrate 346 opposite the processing circuit 344 and communication circuit 342. It will be appreciated that if a suitable communication circuit cannot be formed in the semiconductor substrate 346, then the communication circuit may also be separately formed and then attached via flip-chip or similar type of bonding.

Referring again to FIG. 1, it has been noted previously that the refrigeration system 100 is simplified to aid in exposition of an embodiment of the invention. FIG. 5 shows a more detailed example of a refrigeration system 500 that incorporates embodiments of the invention. The example system 500 of FIG. 5 does not represent any particular preferred form of refrigeration system for use with the arrangement of the invention, and instead is only provided to demonstrate how the concepts of the arrangement of FIG. 1 may be expanded to other devices and elements of an ordinary refrigeration system.

As with the example of FIG. 1, a vapor-compression refrigerator system 500 of FIG. 5 includes the four main components: a compressor 526, a condenser 501, a TEV 512, and an evaporator 518 connected as shown in FIG. 5. In further detail, the compressor 526 is operably coupled to provide compressed refrigerant to a condenser 501 and separately to a hot gas solenoid valve 528. The condenser 501 is coupled to provide refrigerant to a head pressure control valve 502. The head pressure control valve 502 also includes an input connected to a bypass line 548 that is coupled to an input of the condenser 501. The head pressure control valve 502 is operably coupled to provide refrigerant to a receiver 504, which in turn is operably coupled to provide refrigerant to a filter-drier 506. The operations and functions of such devices are well known to those of ordinary skill in the art.

The filter-drier 506 is operably coupled to the thermostatic expansion valve (TEV) 512 through a liquid line solenoid valve 508 and a moisture and liquid indicator 510. The TEV 512 has an output coupled to the evaporator 518 via a distributor 516 as is known in the art. An auxiliary side connector 514 provides a coupling for receiving refrigerant from a discharge bypass valve 530. The discharge bypass valve 530 is coupled to receive refrigerant from the hot gas solenoid valve 528, discussed above.

The evaporator 518, which is suitably located in communication with a compartment to be chilled, not shown, has a refrigerant output connected to an evaporator pressure regulating valve 521. The evaporator pressure regulating valve 521 is operably coupled to provide refrigerant to the suction filter 522. The suction filter 522 is coupled to provide refrigerant to the crankcase pressure regulating valve 224, which in turn is connected to the compressor 526. Such devices and their operation is known in the art.

Also shown in FIG. 5 is another embodiment of an arrangement according to the invention for fault detection and diagnosis of the system 500. The arrangement includes a fault detection and diagnosis (FDD) processor 540, a control station 542 having a user interface, a plurality MEMs wireless sensor modules 520 and a plurality of controller modules 580.

The system 500 of FIG. 5 also includes a distributed control scheme, wherein many individual components have closed loop control arrangements. These control arrangements include, for each device, one or more of the sensor modules 520 and at least one controller module 580. Thus, the wireless sensor modules 520′ and to some degree the controller modules 580 are used for both fault detection and diagnosis as well as distributed control of the system 506.

To provide fault detection as well as control, the sensor modules 520 are placed throughout the system 500. Sensor modules 520 may be configured to obtain measurements of refrigerant parameters and/or measurements of electrical, hydraulic or mechanical parameters of individual devices in the system 500. To this end, the sensor modules 520 include one or more of variety of MEMS sensors to sense different operating characteristics of the system 500. The wireless sensor modules 520 may suitably have the functionality and structure of the microsystem 145₁ of FIGS. 1, 3 and 4, or variants thereof. The sensor modules 520 also include short range wireless communication capability, similar to the microsystem 145₁ of FIGS. 1, 3 and 4.

The controller module 580 may suitably be a microsystem-based controller element, not shown, but which may have a similar structure as the microsystem 145₁. The controller module 580 does not, however, necessarily include a sensor. The controller module 580 has processing circuitry, not shown, operable to perform PI, PID or other types of control algorithm to control one or more actuators in a device under control. The controller module 580 performs such control based on a set point and sensed values received wirelessly from one or more of the wireless sensor modules 520.

By way of example, the liquid line solenoid valve 508 has a controller module 580 that may suitably control the operation of a solenoid to open or close a valve mechanism, based on temperature measurements of the evaporator discharge air received from sensor modules 520 located near the evaporator 518. Various control schemes may be carried on various actuating devices, such as the valves 502, 508, 512, 520, 524, 528 using their controllers 580 and corresponding sensors 520. By way of example, control the head pressure control valve 502 would be a function of pressure measured in the condenser 501. In another example, control of the evaporator pressure regulating valve 521 would be depend on the discharge air temperature in the evaporator 518.

It will be appreciated that the distributed control aspect that is facilitated by the controller modules 580 need not be implemented in order to obtain many of the advantages of the fault detection arrangement of the embodiment of FIG. 5. However, it is noted that the use of microsystems to measure operational parameters of the system 500 for fault detection and diagnosis, as described herein, further facilitates distributed control because of the ready availability of data needed for distributed control.

The wireless sensor modules 520 and controller modules 580 cooperate to form a wireless mesh network that allows communication among any of the nodes, i.e. the sensor modules 520, controller modules 580, the FDD processor 540 and the control station 542, of the system 500. As discussed above in connection with the embodiment of FIG. 1, the wireless mesh network allows for transmission between any two nodes using a series of short transmission hops between closely located nodes. Accordingly, if a sensor module 520 needs to communicate with the FDD processor 540, the sensor module 520 may communicate either directly with the FDD processor 540 (if closely located) or through a series of intermediate sensor modules 520 and/or controller modules 580.

In general, the sensor modules 520 obtain measurements of parameters of the refrigerant, such as temperature and pressure, and provides the information to the FDD processor 540. If the measurements obtained by a sensor modules 520 are also useful for control of a device within the system 500, the sensor module 520 also provides the information to the controller 580.

In any event, in the fault detection and diagnosis operation, the FDD processor 540 compares the values, or combinations of the values, to one or more reference values. The reference values may suitably represent the limits of the acceptable value range for the measured value or combination of measured values being compared. The FDD processor 540 selectively generates an alarm or fault message based on the outcome of the comparison. In particular, if the result of the comparison corresponds to the value or combination of values being within an accepted range, then an alarm message is not generated. If, however, the result of the comparison corresponds to the value or combination of values being outside an accepted range, then the alarm message is generated. If the alarm message is generated, the FDD processor 540 stores the message. Other measured values may be stored or linked to the alarm event so that when the alarm is analyzed, other conditions in the system that existed at the time of the alarm may be observed and considered.

To this end, the FDD processor 540 may suitably carry out operations analogous to those of the processing circuit 152 of the controller 150 of FIG. 1.

Thus, in an exemplary operation, the FDD processor 540 tests from time to time the differential in pressure between the input and output of the TEV 512. Thus, the sensor modules 520 at the input and output of the TEV 512 obtain pressure measurements (Pin, Pout) and communicate the measurements to the FDD processor 540. The FDD processor 540 compares the difference in pressure, or Pin−Pout to at least one threshold to determine if the difference in pressure is excessive. If so, then the FDD processor 540 generates an alarm message or alarm record. The FDD processor 540 stores the alarm message as well as other sensor values measured in the system 500 at about the same time.

In the example of FIG. 5, it will be appreciated that each sensor module 520 is located in a sensing relation with the process variable that it is intended to sense. For example, pressure and temperature sensors in a sensor module 520 may be in contact with the refrigerant at various locations. Other sensor modules 520 may include electrical sensors (e.g. MEMs Hall-effect sensors) to measure current and/or voltage that are disposed near an electrical power input conductors.

Thus, the FDD processor 540 combined with the sensor data from the sensor modules 520 can help improve the fault detection in the system 500. The additional information allows for improved fault detection due to the large amount of system information.

The FDD controller 540 may suitably be constructed based on a commercially available building automation system design, such as an MEC, TEC, Talon or Saphir controller available from Siemens Building Technologies, Inc. of Buffalo Grove, Ill. Such controllers may be adapted to carry out the operations described herein. The FDD controller 540 in one embodiment employs a BACnet-based protocol for exchanging information with the work station 542 and in many cases the controllers 580 and sensor modules 520. Both standard and proprietary objects can be employed.

For the purposes of the distributed control scheme of the embodiment of FIG. 5, the FDD controller 540 is further configured to receive select information from the controllers 580 and sensor modules 520 for the purpose of monitoring system performance to accurately predict and communicate system faults and inefficiencies. For example, instead of merely monitoring process variables, the FDD controller 540 may suitably monitor the output control variables of the FDD controller 540 to detect poor response or operation of device.

The FDD controller 540 may include a display, as is typical of higher end commercially available field controllers. In such a case, the FDD controller 540 may be configured to display select data relative to all smart system components, such examples include, but are not limited to: learned set points, component in-service and cumulative run time, valve positions, system case and discharge air temperatures, I/O status, select system high & low side pressures, oil levels, presence of refrigerant gas, and other select information.

The FDD controller 540 reports communication loss messages for all nodes on the network, and is responsible for logging pertinent system information into non-volatile memory, not shown. This information is accessible over the system network to allow it to be quarried, emailed, output to an spreadsheet file, printed, or displayed locally and remotely upon demand. These operations may alternatively be performed by the work station 542

The FDD controller 540 includes a non-volatile memory, not shown, that stores the baseline data, including energy consumption levels to create the system signature. It is this system signature, for example, the pressure-enthalpy curve, that form the basis for the reference values used in the comparison operations discussed further above.

In one embodiment, when the FDD controller 540 identifies an FDD event, an appropriate alarm shall be sent over the building automation network so that the problem can be pinpointed to maximize the efficiency of monitoring and maintenance personnel or other dispatched service.

The user interface (UI) control station 542 is a computer workstation or the like that allows a technician to locally or remotely configure the controllers 580 and sensors 520. The UI control station 542 preferably also allows the user to monitor the system by interrogating the FDD controller 540 or other individual component to observe the operation of the system 500.

In a preferred embodiment, the UI control station 542 includes a web browser based interface for displaying and organizing the requested system information. The web-browser based-interface allows for local or remote system configuration and data monitoring, including historical and real time graphing and display of data logs for individual smart system components or the overall system with user friendly, easy navigability, displaying as much information as possible in both text and graphical formats. A suitable control station is an INSIGHT™ model control station, available from Siemens Building Technologies, Inc. of Buffalo Grove, Ill., which has been modified to carry out the operations described herein.

In the discussions of FIGS. 1 and 5 above, it is noted that many of the sensor modules 145₁, 520 are configured to obtain temperature and pressure of the refrigerant at various locations in the refrigeration systems 100, 500 respectively. One exemplary method for implementing those sensor modules 520 is through a coupling device that incorporates a sensor.

FIG. 6 shows a “smart” coupling unit 600 that may be used to obtain sensor data from refrigerant at various points in the system 500 of FIG. 5 (or even the system 100 of FIG. 1). The coupling unit 600 is a relatively short length of pipe that includes, in this embodiment, a central pipe portion 602, a first coupling end 604, a second coupling end 606 and a sensor module 520. The first coupling end 604 is configured to receive and couple to a pipe or fitting 608 of a system component, and the second coupling end 606 is configured to receive and couple to another pipe or fitting 610. The coupling ends 604, 606 may be threaded or non-threaded, and may take any form suitably used by refrigeration devices to couple pipes and/or fittings. In use, the coupling ends 604, 606 receive the pipe/fittings 608, 610, respectively, and may be brazed or soldered to secure the connection.

The wireless sensor module 520 is preferably securedly fixed in the interior of the central pipe portion 602 such that the sensors thereon are in a position to sense conditions of refrigerant passing through the pipe between the pipes 608 and 610. Then sensor module 520, as discussed above, preferably includes pressure and temperature sensors. An example of such a module is shown in FIGS. 3 and 4. In other embodiments, the sensor module 520 may additionally (or alternatively) contain MEMS sensors that detect contaminants, such as water vapor.

The smart coupling unit 600 inserted at any point in the system 100 in which there is refrigerant pipe, such as between any two elements of the system 500 shown in FIG. 5. The sensor module 520 is preferably secured to the pipe portion 602 such that the sensing portion 340 (See FIGS. 3 and 4) is in the flow stream of the refrigerant within the pipe portion 602. To facilitate low power RF communications from the sensor module 520 from inside of the pipe portion 602, the pipe portion 602, a first coupling end 604, a second coupling end 606 may be made transparent, such as of glass or the like. Alternatively, the coupling unit 600 may be outfitted with two wireless modules, the wireless module 520 on the inside that generates the measurements, and a wireless module (with or without sensors), not shown, secured to the outside of the pipe portion 602 that acts as an RF relay. The pipe portion 602 need not then be transparent or otherwise RF friendly because the transmission distance between the inside module 520 and the external module, not shown in FIG. 6, is very small.

One of the advantages of at least some embodiments of the invention arises from the fact that the microsystems (sensor modules 520) are relatively small, and perform wirelessly. This allows many sensor modules 520 to be used in a single system. Listed below are examples of what kinds of microsystem sensors may be appropriate and/or useful for fault diagnosis and detection in a refrigeration device.

### Sensor Values for Expansion Valves

Expansion valves such as the TEV 110 of FIG. 1 and the TEV 512 of FIG. 5 are an integral part of most refrigeration systems. These expansion valves may be manual, automatic, mechanical, thermostatic, electric or electronic. Wireless and/or MEMs-based sensor modules could be used to measure the following TEV parameters, which would be beneficial for fault detection operations: Inlet refrigerant pressure and refrigerant temperature; Outlet refrigerant pressure and refrigerant temperature; Valve percent open position; Refrigerant mass flow rate; Driver motor voltage; Driver Motor amperage; Network communications proof; and wireless signal strength.

Another set of expansion devices used in refrigeration systems include capillary tubes, cap flo-raters, restrictors, and orifice-based refrigerant expansion devices. Wireless and/or MEMs-based sensor modules could be used to measure the following parameters for these devices, which would be beneficial for fault detection operations: Inlet refrigerant pressure and refrigerant temperature; Outlet refrigerant pressure and refrigerant temperature; Refrigerant mass flow rate; Network communications proof; and wireless signal strength.

### Sensor Values for Evaporator Units

Evaporator units such as the evaporator 115 of FIG. 1 and the evaporator 518 of FIG. 5 are another integral part most refrigeration systems. Wireless and/or MEMs-based sensor modules could be used to measure the following evaporator parameters, which would be beneficial for fault detection operations:: Inlet refrigerant pressure and refrigerant temperature; Outlet refrigerant pressure and refrigerant temperature; Refrigerant mass flow rate; Network communications proof; and wireless signal strength.

Evaporator units also typically include a pressure regulator, such as the evaporator pressure regulating valve 521. Evaporator pressure regulators may be manual, automatic, mechanical, electric or electronic. Wireless and/or MEMs-based sensor modules could be used to measure the following device parameters, which would be beneficial for fault detection operations: Inlet refrigerant pressure and refrigerant temperature; Outlet refrigerant pressure and refrigerant temperature; Valve percent open position; Refrigerant mass flow rate; Driver motor voltage; Driver motor amperage; Network communications proof; and wireless signal strength.

### Sensor Values for Condensor Equipment

Most refrigeration systems include a head pressure regulator, such as the head pressure control valve 502, at the output of the condenser 500. As with other devices, the head pressure regulator may be of several designs, including manual, automatic, mechanical, electric or electronic. Wireless and/or MEMs-based sensor modules could be used to measure the following parameters for these devices, which would be beneficial for fault detection operations: Inlet refrigerant pressure and refrigerant temperature; Outlet refrigerant pressure and refrigerant temperature; Valve percent open position; Refrigerant mass flow rate; Driver motor voltage; Driver motor amperage; Network communications proof; and wireless signal strength.

### Sensor Values for Compressor Units

Evaporator units such as the evaporator 120 of FIG. 1 and the compressor 526 of FIG. 5 are yet another integral part most refrigeration systems. Wireless and/or MEMs-based microsystem sensors may be used to obtain the following types of measurements or information that would be beneficial for fault detection operations: Oil sump temperature; Inlet suction refrigerant pressure and refrigerant temperature; Outlet discharge refrigerant pressure and refrigerant temperature; Internal discharge refrigerant pressure and refrigerant temperature located inside each cylinder discharge cavity or top cap, or any scroll discharge cavity or top cap, or any rotary discharge cavity or top cap or any screw discharge cavity or top cap; Internal compressor motor electrical windings temperatures; Internal compressor motor electrical windings relative displacement; Compressor supply voltage measured between each voltage leg; Compressor supply amperage measured on each voltage leg; Compressor supply voltage frequency; Compressor inlet refrigerant mass flow rate; Compressor outlet refrigerant mass flow rate; Compressor body vibration; Compressor crankcase oil level; Compressor oil moisture indicator; Compressor oil acid pH indicator; Compressor oil pressure (if applicable); Compressor motor compartment pressure and temperature; Compressor unloader or capacity control device percent open position or duty cycle percent; Network communications proof; and Wireless signal strength

A device that is typically associated with the compressor is a compressor pressure regulator, such as the crankcase pressure regulating valve 524. Wireless and/or MEMs-based microsystems may be used to measure the following quantities of the compressor/crankcase pressure regulator; Inlet refrigerant pressure and refrigerant temperature; Outlet refrigerant pressure and refrigerant temperature; Valve percent open position; Refrigerant mass flow rate; Driver motor voltage; Driver motor amperage; Network communications proof; and wireless signal strength.

### Other Devices

There are several other devices common to refrigeration systems. One such device is a defrost pressure differential valve, which is not shown FIG. 5, but would be known to those of ordinary skill in the art. In defrost pressure differential valves, wireless and/or MEMs-based sensor modules similar to that of FIGS. 3 and 4 may be used to measure the following quantities: Inlet refrigerant pressure and refrigerant temperature; Outlet refrigerant pressure and refrigerant temperature; Valve percent open position; Refrigerant mass flow rate; Driver motor voltage; Driver motor amperage; Network communications proof; Wireless signal strength.

Similar measurements may be made by wireless sensor modules for 3-way heat reclaim valves, refrigerant flow check valves, refrigerant flow solenoid valves, oil level control valves, and oil differential pressure valves, which are employed in many commercial refrigeration systems. However, in the case of oil level control valves and oil pressure differential valves, the mass flow rate of the oil is measured as opposed to the mass flow rate of the refrigerant. In this manner, various aspects of the hydraulic circuit, not shown in FIG. 5, may be monitored for faults.

Another refrigeration system device is the receiver, such as the receiver 504 of FIG. 5. In the receiver, wireless and/or MEMs-based sensor modules similar to that of FIGS. 3 and 4 may be used to measure the following quantities: Vessel percent full; Vessel weight; Vessel temperature; Vessel pressure; Network communications proof; and wireless signal strength.

Another refrigeration system device is the refrigerant moisture indicator, such as the moisture and liquid indicator 510 of FIG. 5. In the refrigerant moisture indicator, wireless sensor modules similar to that of FIGS. 3 and 4 may be used to measure the following quantities: PPM water; Network communications proof; and wireless signal strength.

Another refrigeration system device is an acid indicator, not shown in FIG. 5 but would be known in the art. In the acid indicator, wireless and/or MEMs-based sensor modules similar to that of FIGS. 3 and 4 may be used to measure the following quantities: pH Level; pOH Level; Network communications proof; and wireless signal strength.

The various values generated by the wireless sensors in the above describe devices may be compared to baseline (reference) values to determine whether a fault exists. More or less wireless sensors may be employed by any one system.

It will be appreciated that the above described embodiments are merely exemplary, and that those of ordinary skill in the art may readily develop their own modifications and implementations that incorporate the principles of the invention and fall within the spirit and scope thereof.

We claim:

1. An arrangement, comprising:
a plurality of MEMs sensors, each sensor operably coupled to measure a parameter of a refrigeration system, each sensor coupled to one of a plurality of wireless transmission devices;
a processing circuit configured to receive first information based on the parameters of the refrigeration system from the wireless transmission devices, the processing circuit further operable to,
compare the first information to one or more reference values; and
generate a first message conditionally, based on the result of the comparison.

2. The arrangement of claim 1, wherein the first information includes information regarding an enthalpy of the refrigeration system.

3. The arrangement of claim 1, wherein the first information includes a plurality of refrigerant temperature measurements and a plurality of refrigerant pressure measurements.

4. The arrangement of claim 1, wherein the one or more reference values includes at least a first threshold value for change in a refrigerant parameter between two points of the refrigeration system.

5. The arrangement of claim 1, wherein the first information includes a first value of a first parameter of the refrigerant measured at an input of a first device of the refrigeration system, and a second value of the first parameter measured at an output of the first device.

6. The arrangement of claim 5, wherein the one or more reference values include at least a first threshold value for a change in the first parameter between the input and the output of the first device.

7. The arrangement of claim 1, wherein the first information includes a plurality of values of one or more parameters of the refrigerant, the plurality of values including at least two values measured proximate to each of a plurality of devices of the refrigeration system.

8. The arrangement of claim 7, wherein the processing circuit is further operable to generate a first message conditionally, based on the result of the comparison; by
identifying any of the plurality of devices providing below normal operation based on the result of the comparison;
generating the first message such that the first message indicates any of the plurality of devices identified as providing below normal operation.

9. The arrangement of claim 1, further comprising a communication circuit, the communication circuit configured to transmit the fault information representative of the first message to a remote device.

10. A method comprising:
a) generating first information based on a measurement of a parameter of a refrigeration system in each of a plurality of MEMs sensors;
b) transmitting the first information wirelessly to a processing circuit;
c) comparing the first information to one or more reference values; and
d) causing the processing circuit to generate a first message conditionally, based on the result of the comparison.

11. The method of claim 10, wherein step a) further comprises generating the first information to include information regarding an enthalpy of the refrigeration system.

12. The method of claim 10, wherein step a) further comprises generating the first information to include refrigerant temperature measurements and refrigerant pressure measurements.

13. The method of claim 10, wherein the one or more reference values includes at least a first threshold value for change in a refrigerant parameter between two points of the refrigeration system.

14. The method of claim 10, wherein step a) further comprises generating the first information to include a first value of a first parameter of the refrigerant measured at an input of a first device of the refrigeration system, and a second value of the first parameter measured at an output of the first device.

15. The method of claim 14, wherein the one or more reference values include at least a first threshold value for a change in the first parameter between the input and the output of the first device.

16. The method of claim 10, wherein step a) further comprises generating the first information to include a plurality of values of one or more parameters of the refrigerant, the plurality of values including at least two values measured proximate to each of a plurality of devices of the refrigeration system.

17. The method of claim 16, further wherein step d) further comprises:
identifying any of the plurality of devices providing below normal operation based on the result of the comparison;
generating the first message such that the first message indicates any of the plurality of devices identified as providing below normal operation.

18. An arrangement, comprising:
a plurality of wireless sensor modules, each sensor module operably coupled to measure a parameter of a refrigeration system, each sensor module including a wireless transmission device;
a processing circuit configured to receive first information based on the parameters of the refrigeration system from the wireless transmission devices, the processing circuit further operable to,
compare the first information to one or more reference values; and
generate a first message conditionally, based on the result of the comparison.

19. The arrangement of claim 18, wherein the first information includes a plurality of values of one or more parameters of the refrigerant, the plurality of values including at least two values measured proximate to each of a plurality of devices of the refrigeration system.

20. The arrangement of claim 18, wherein each of the wireless sensor modules includes at least one MEMS sensor.
